(19) United States
(12) Patent Application Publication
(10) Pub. No.: US 2008/0183678 A1
(43) Pub. Date: Jul. 31, 2008

(54) Systems and methods for personalizing responses to user requests

(76) Inventors: Denise Chapman Weston, Wakefield, RI (US); Ronald Dean Eaglin, Oviedo, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/963,594

(22) Filed: Dec. 21, 2007

Related U.S. Application Data
(60) Provisional application No. 60/882,866, filed on Dec. 29, 2006.
(60) Provisional application No. 60/995,305, filed on Sep. 26, 2007.

(51) Int. Cl. G06F 17/30

(52) U.S. Cl. 707/3; 707/E17.108

(57) ABSTRACT

Computing systems and methods include a virtual character configured to provide personalized interaction with a user to help the user attain his or her goals. For example, the virtual character can customize responses and/or delivery of the responses to a user request, such as a question or a search request, by accessing information regarding goals and/or the personality of the user. In other examples, the virtual character can develop its own personality to complement the personality of the user. The virtual character can advantageously be accessed by the user via one or more electronic devices in communication with a server device, which determines the response to the user request. In certain examples, the response is based on stored responses to previous requests by the user and/or other individuals with similar personality traits and/or goals of the user.

### REFERENCE TO RELATED APPLICATIONS

This application claims the benefit of priority under 35 U.S.C. § 119(e) of U.S. Provisional Patent Application No. 60/882,866, filed Dec. 29, 2006, entitled SYSTEMS AND METHODS FOR CREATING AND MAINTAINING AN INTERACTIVE VIRTUAL CHARACTER, and U.S. Provisional Patent Application No. 60/995,305, filed Sep. 26, 2007, entitled SYSTEMS AND METHODS FOR CREATING AND MAINTAINING AN INTERACTIVE VIRTUAL CHARACTER, each of which is hereby incorporated herein by reference in its entirety and is to be considered part of this specification.

### BACKGROUND

1. Field of the Invention

Embodiments of the invention relate generally to interactive entertainment and, in particular, to systems and methods for providing a virtual character for personalized interaction with a user.

2. Description of the Related Art

Recent years have seen a proliferation of online communities in which users interact with online avatars or characters to participate in a virtual world. These online communities often include games, chatting capability or allow users to create and/or trade virtual property.

Interaction between the user and the virtual character, however, is substantially limited in that conventional virtual characters are often passive in nature. For example, when participating in an online community or game, a user generally registers or creates the virtual character and then must directly control the motions and/or activities of the virtual character. Moreover, use of the virtual character is generally limited to a desktop or similar computer and encourages the user to spend more time in front of the computer screen.

### SUMMARY

In light of the foregoing, a need exists for users to interact with a more robust, emotionally intelligent avatar or virtual character that better understands the user and his or her goals and personality. A need also exists for an avatar or character that can provide more interaction with a user than merely access to an online game or chatting capability. For example, there is a need for interactive virtual characters that encourage users to get away from the computer screen and that provide personalized responses, advice and/or suggestions to a particular user.

Certain embodiments of the invention provide a method for responding to a user request. The method includes receiving a request from a user; performing a search for the requested information to obtain a set of search results; retrieving user information that includes goal data and personality data; filtering the set of search results to match the user's goal data; preparing presentation results for presentation to the user using the search results and the personality data; and returning the presentation results, such as through a virtual character.

Certain embodiments of the invention provide a computing system for generating personalized responses to one or more user requests. The computing system includes an user interaction module configured to receive a request from a user and a determination module configured to: perform a search for the requested information to obtain a set of search results, retrieve user information that includes goal data and personality data, filter the set of search results to match the user's goal data, and prepare presentation results for presentation to the user using the search results and the personality data. In certain further embodiments, the presentation results can include a virtual character that performs animations for entertainment purposes based on the user request.

In certain embodiments, a method is disclosed for personalizing a response to a user request. The method comprises: receiving from a user a request for information; generating a set of search results in response to the user request; retrieving a user profile, the user profile including both user goal data indicative of one or more goals of the user and personality data; filtering the set of search results based at least in part on the user goal data; generating presentation results for presenting one or more responses to the user according to the personality data, the one or more responses comprising at least a portion of the filtered search results; and returning the presentation results. In certain further embodiments, said presenting one or more responses comprises a virtual character presenting the one or more responses.

In certain embodiments, a computing system is disclosed for personalizing a response to a user request. The computing system includes a client device comprising a user interaction module configured to receive from a user a request for information. The computing system also includes a server device in network communication with the client device, the server device being remotely located with respect to the client device and configured to receive the user request for information from the client device. The server device further comprises a request module configured to: perform a search for the requested information to obtain a set of search results, retrieve goal data indicative of one or more goals of the user, retrieve personality data indicative of one or more personality traits of the user, filter the set of search results based at least in part on the goal data, and generate presentation results for presenting one or more responses to the user according to the personality data, the one or more responses comprising at least a portion of the filtered search results. In certain further embodiments, the client device further comprises a display, and the user interaction module is further configured to communicate the presentation results to the user through a virtual character on the display.

In certain embodiments, a system is disclosed for providing personalized responses to user requests. The system comprises a plurality of client devices, each client device comprising a user interface for displaying a virtual character and a user interaction module for receiving from a user one or more requests for information. The system further comprises a server device in network communication with each of the plurality of client devices, the server device being configured to receive the one or more user requests for information from one or more of the plurality of client devices. The server device further includes a request module configured to, for each of the one or more user requests: perform a search for the requested information to obtain a set of search results, retrieve goal data indicative of one or more goals of the user, retrieve personality data indicative of one or more personality traits of the user, filter the set of search results based at least in part on the goal data, generate presentation results for presenting one or more responses to the user according to the personality data, the one or more responses comprising at least a portion of said filtered search results, and send the presentation results to the particular client device that received the particular user request for information. Moreover, the particular client device can be configured to communicate the presentation results to the user via the virtual character of the particular client device.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a block diagram of a computer system for personalizing responses to one or more user requests, according to certain embodiments of the invention.

FIG. 2 illustrates a block diagram of an exemplary embodiment of a client system of the computer system of FIG. 1.

FIG. 3 illustrates a block diagram of an exemplary embodiment of a server system of the computer system of FIG. 1.

FIG. 4 illustrates a flowchart of an exemplary embodiment of a method for processing user requests usable by the computer system of FIG. 1.

FIG. 5 illustrates a flowchart of an exemplary embodiment of a method for processing user requests usable by the server system of FIG. 3.

FIG. 6 illustrates a flowchart of an exemplary embodiment of a method for personalizing responses to a user request usable by the computer system of FIG. 1.

FIGS. 7A-7C illustrate exemplary embodiments of a computer screen display including an interactive character of the computer system of FIG. 1.

FIGS. 8A-8E illustrate other exemplary embodiments of a cell phone screen display including an interactive character of the computer system of FIG. 1.

FIGS. 9A and 9B illustrate exemplary embodiments of user profile information that has been assigned to one or more virtual characters.

### DETAILED DESCRIPTION OF PREFERRED EMBODIMENTS

Certain embodiments of the invention provide for a personalized virtual character capable of interaction with an individual through multiple electronic devices. For example, the interactive character can be configured to perform actions and tasks and have human-like emotions, without necessarily being human-like in appearance. In certain embodiments, the electronic character can advantageously interact with humans through natural language interaction so as to establish and maintain a companionship relationship with its user.

In certain embodiments, the interactive character can take on a variety of forms, some of which may be licensed commercial characters. Moreover, the interactive character can advantageously learn from the experiences and requests made to other interactive characters by their owners. In certain embodiments, the interactive character can perform tasks like finding a phone number, recommending a restaurant, and so forth. Moreover, the interactive character is advantageously available to the user on multiple devices and can function as the same basic character regardless of the device on which the character is displayed.

In certain embodiments of the invention, the interactive character assists a user or owner in attaining his or her goals. For example, the interactive character can access rules and/or processes drawn from professional development programs that focus on goal achievement and skill building for encouraging confidence, leadership, personal management and direction.

The interactive character can also advantageously be sensitive to personality styles. For example, if a user or owner has a passive approach to life but tends to reach lower-level goals through interaction with an “assertive” character, the interactive character can intelligently adjust its approach to fit the personality style of the user. Moreover, if a user shows frustration by constantly turning off the interactive character because it is getting too aggressive in its communication with the user, the interactive character can “back off” and find other ways to support the person to achieve his or her goals.

In certain embodiments of the invention, the interactive character functions as a living being and “learns” the emotional cues of its owner and grows emotionally to be “one step ahead” in order to provide guidance and direction. In embodiments of the invention that are focused on goal setting, which can be emotional and/or interest based, the interactive character can interact with and seek engagement from the owner in a two-way relationship that supports goal setting and personal growth. In doing so, the interactive character can employ intelligent algorithms to constantly seek and learn patterns of behavior and choices the owner is making, as well as reviewing what other owners with similar goals are choosing to do in order to give “one step ahead” feedback and suggestions.

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the invention and not to limit the scope of the disclosure.

In addition, methods and functions described herein are not limited to any particular sequence, and the blocks or states relating thereto can be performed in other sequences that are appropriate. For example, described blocks or states may be performed in an order other than that specifically disclosed, or multiple blocks or states may be combined in a single block or state.

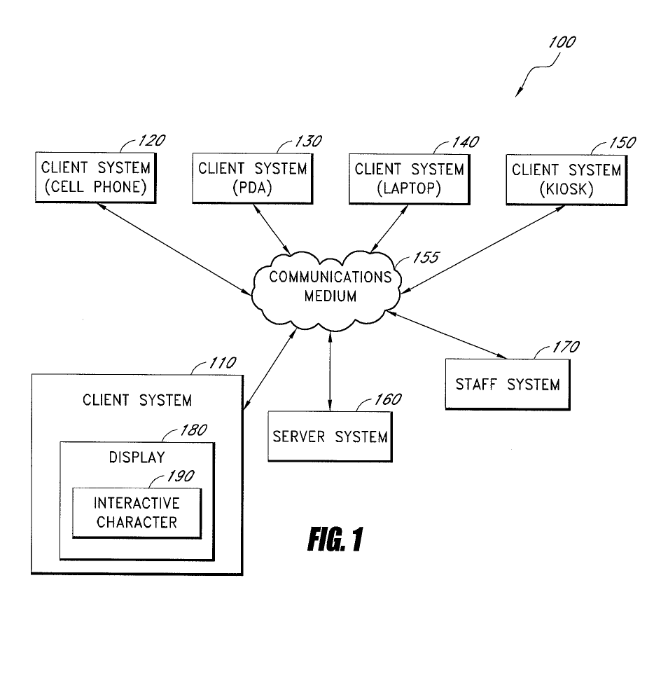

FIG. 1 illustrates a block diagram of a computer system 100 for personalizing responses to one or more user requests or queries, according to certain embodiments of the invention. In certain embodiments, the computer system 100 employs an interactive, virtual character that responds to user requests and/or provides personalized information or recommendations to the user.

As shown, the computer system 100 includes a plurality of client systems 110, 120, 130, 140 and 150 in network communication with a server system 160 via a communications medium 155. In certain embodiments, the client systems 110, 120, 130, 140 and 150 can include any type of portable or stationary electronic device capable of communicating with the server system 160. Moreover, each of the client systems 110, 120, 130, 140 and 150 preferably includes a user interface for displaying information to and/or receiving requests or queries from a user.

As shown, the client system 120 comprises a cell phone, the client system 130 comprises a personal digital assistant (PDA), the client system 140 comprises a laptop, and the client system 150 comprises a kiosk. In other embodiments, one or more of the client systems can comprise a workstation, a personal computer, a smartphone, a pager, a wand, a media player, combinations of the same and the like. Other examples of client systems usable with the computer system 100 are discussed in more detail below.

The server system 160 comprises one or more computing devices capable of responding to requests from one or more of the client systems 110, 120, 130, 140 and 150. In certain embodiments the server system 160 maintains one or more databases for storing information related to controlling an interactive character maintained on one or more of the client systems. For instance, the server system 160 can include information for responding to one or more user requests received by a client system and/or for instructing an interactive character in communicating with the user.

The computer system 100 also includes a staff system 170 in communication with one or more of the client systems 110, 120, 130, 140 and 150 and/or the server system 160. The staff system 170, in certain embodiments, advantageously receives requests from the client systems 110, 120, 130, 140 or 150 and/or the server system 160 that cannot be addressed by the client systems or the server system. For example, the staff system 170 can include a queue or other data structure that stores the requests, while in other embodiments, the requests can be stored in a queue on the client system and/or the server system 160.

In one embodiment, the staff system 170 comprises a server that processes requests from the queue and routes them to individuals with access to the staff system 170 that research the requests and provide responses back to the staff system 170. The responses are then routed to the appropriate client system 110, 120, 130, 140 and 150 and/or the server system 160. In other embodiments, individuals can utilize the staff system 170 to conduct the research and/or respond to the requests.

As illustrated, the client system 110 further includes a display 180 that contains an interactive character 190. In certain embodiments, the interactive character 190 comprises a virtual character that interacts with the user to provide responses to user requests, to play games with the user, to provide personalized information and/or encouragement to the user, combinations of the same or the like.

In certain embodiments, the user initializes and/or creates the virtual character 190 by installing software instructions on one or more processors of the client system 110 or the server system 160. In some embodiments, the user may have the option of customizing the virtual character 190. In some embodiments, the virtual character 190 is displayed on a designated portion of a computer screen. For example, the virtual character 190 may sit in the corner of the screen (such as the “Office Assistant” character in the MICROSOFT WORD program).

In some embodiments, the virtual character 190 utilizes artificial intelligence algorithms to “learn” about his or her user. For instance, the virtual character 190 may learn a specific goal of the user, such as, for example, a goal to lose weight. The virtual character 190 can then assist the user in attaining his or her goal by encouraging the user and/or providing information or services relating to training, calorie counting, fitness, pertinent literature and/or online information, special shows or events, combinations of the same or the like. In yet further embodiments, corporate sponsors (for example, JENNY CRAIG or WEIGHT WATCHERS) can participate with and/or associate with the virtual character 190 to assist the user in his or her goal.

The computer system 100, in certain embodiments, provides a user with access to the interactive character 190 in a variety of embodiments and/or through a variety of client systems. The following provides a few examples of how the computer system 100 can use the virtual character 190.

In some embodiments, a user can access the virtual character 190 from a variety of electronic devices, including, for example, from a home computer, laptop computer, work computer, mobile phone (for example, a mobile phone utilizing the ANDROID platform provided by Google), music player device, global positioning system (GPS) device, PDA, server, computer workstation, local area network of individual computers, handheld computer, an embedded computing device, car system, as well as a computing system that accesses the Internet. In addition, the user may access the virtual character 190 from a kiosk or a computing system located in a third-party location, such as, for example, a store, a restaurant, a school, an airport, a train station, a bus station, a hotel, an amusement park, a library, a doctor's office, an airplane, a train, a bus, combinations of the same or the like.

In further embodiments, the virtual character 190 may be transported and/or accessed on one or more portable (carrying) devices. For instance, information relating to the character 190 may be loaded to a portable computing device, such as, for example, a PDA, a laptop, a cell phone, a BLACKBERRY device, an IPOD, a portable gaming device, a thumb drive, a universal serial bus (USB) key, combinations of the same or the like. In some embodiments, the information relating to the virtual character 190 be stored in a memory of any portable object, such as, for example, a stuffed animal, a magic wand, 3-D glasses, combinations of the same or the like.

In some embodiments, the device for “carrying” the virtual character 190 comprises a user interface that allows for interaction between the user and the virtual character 190. For example, the carrying device can comprise a screen for displaying the virtual character 190 and/or speakers for outputting audio from the virtual character 190. In some embodiments, the user interface of the carrying device can comprise a keyboard, one or more buttons or switches, a touch screen, voice recognition modules, combinations of the same or the like for receiving input from the user.

In certain embodiments, the carrying device can further include additional modules for receiving other information that may be of interest to the user and/or for use by the virtual character 190. For example, the carrying device may integrate GPS technology for detecting the device's location and/or nearby venues of interest (for example, stores, restaurants, entertainment facilities, other virtual characters and/or users, movies, parks, schools, religious establishments, transportation venues, malls, fitness centers, shopping malls, supermarkets, medical offices, hospitals, work locations, combinations of the same or the like). In other embodiments, the carrying device may be configured to access a public network, such as the Internet, and/or engage in an online messaging service.

In some embodiments, the carrying device is further configured to communicate with one or more interactive stations to receive and/or send information relating to the virtual character 190. For example, in some embodiments, the interactive stations may comprise one or more of the following: a docking station, a cradle, infrared transceiver, radio frequency (RF) transceiver, a barcode reader, a cellular communication station, an interactive television, a gaming system, a scanning device, a WiFi station, a BLUETOOTH station, combinations of the same or the like. In some embodiments, the interactive stations may comprise one or more computing devices that communicate with the carrying device, such as through a USB cable, BLUETOOTH, firewire, combinations of the same or other like communication.

In some embodiments, the interactive stations may be located at one or more venues detailed above. For instance, in some embodiments, the carrying device may communicate with an interactive station in a particular venue to receive particular types of information, such as, for example: venue-specific information, updates, credit information (for example, points for visiting the venue), health care updates, “secrets,” discounts, specials, sales, movie listings, tips, words of wisdom, jokes, combinations of the same or the like. The data received from the interactive station may be stored on the memory (such as a flash memory) of the carrying device, a central database in communication with the carrying device, and/or later downloaded to a home computing system.

In some embodiments, the interactive station can be positioned at a point of sale (POS) location of a retailer, restaurant, store, supermarket or the like. When the user purchases an item or service at the POS location, the carrying device can communicate with the interactive station(s) to allow the same or similar item or service to be available to the virtual character 190. For instance, if a user purchases a sweater from the GAP clothing retailer, the interactive station can make available to the carrying device a corresponding virtual sweater for the virtual character 190. Similar virtual transactions may be performed with respect to a household furnishing purchases (for example, decorating a virtual character's room), car purchases, food purchases (for example, “stocking” the virtual character's refrigerator) or the like.

In some embodiments of the invention, household devices may be configured to communicate with the carrying device and/or process information relating to the virtual character 190. For instance, such household devices may comprise, but are not limited to: alarm clocks, stereo systems, televisions, gaming systems, appliances, combinations of the same or the like.

In certain embodiments of the invention, the control of the interactive character 190 is server based. For instance, in embodiments wherein the interactive character 190 is portrayed through multiple electronic devices, the devices can have a consistent user interface and interactive character reactions across the devices. In such embodiments, user interactions with the interactive character 190 (for example, user requests) are sent to the server, and responses are relayed back to the client system and interactive character 190 for “performance.”

In certain embodiments, one or more of the client systems 110, 120, 130, 140, 150, the server system 160 and the staff system 170 can include a general purpose single-chip or multi-chip microprocessor such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor. Furthermore, any of the aforementioned systems can be used in connection with various operating systems such as, for example: Microsoft® Windows® 3.X, Microsoft® Windows 95, Microsoft® Windows 98, Microsoft® Windows® NT, Microsoft® Vista, Microsoft® XP, Microsoft® Windows® CE, Palm Pilot OS, OS/2, Apple® MacOS®, Disk Operating System (DOS), UNIX, Linux®, VxWorks, or IBM® OS/2®, Sun OS, Solaris OS, IRIX OS operating systems, ANDROID mobile phone operating system, or the like.

It will also be appreciated from the disclosure herein that one or more of the client systems 110, 120, 130, 140, 150, the server system 160 and the staff system 170 can include various sub-routines, procedures, definitional statements and macros. Each of the foregoing modules are typically separately compiled and linked into a single executable program. However, it is to be appreciated that the processes that are performed by selected ones of the modules can be arbitrarily redistributed to one of the other modules, combined together in a single module, made available in a shareable dynamic link library, or partitioned in any other logical way.

Moreover, the communications medium 155 can include one or more of any type of electronically connected group of computers including, for example, the following networks: a virtual private network, a public Internet, a Internet, a secure Internet, a private network, a public network, a value-added network, a wired network, a wireless network, an intranet and the like. In addition, the connectivity to the communications medium 155 may be, for example, via remote modem, Ethernet (IEEE 802.3), Token Ring (IEEE 802.5), Fiber Distributed Datalink Interface (FDDI) or Asynchronous Transfer Mode (ATM). For instance, the communications medium 155 can connect to the client systems 110, 120, 130, 140, 150, the server system 160 and/or the staff system 170, for example, by use of a modem or by use of a network interface card that resides in each of the systems.

In addition, the same or different communications media 155 can be used to facilitate communication between any of the client systems 110, 120, 130, 140, 150 and the server system 160, between the server system 160 and the staff system 170, and between any of the client systems 110, 120, 130, 140, 150 and the staff system 170.

In certain preferred embodiments, communication between the various components of the computing system 100 can include eXtensible Markup Language (XML) and/or Web Services protocol.

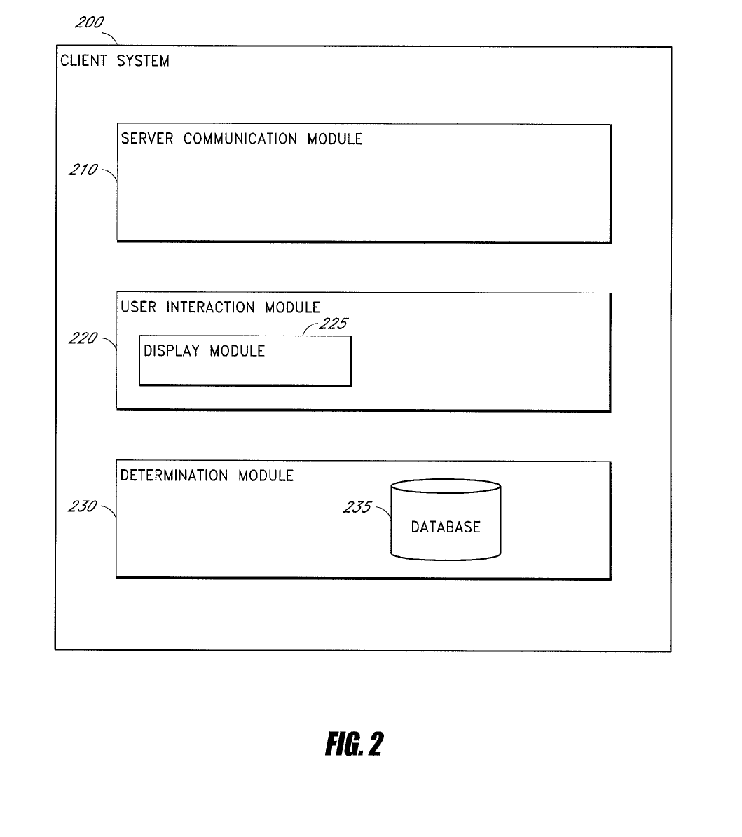

FIG. 2 illustrates a block diagram of further details of a client system 200, according to certain embodiments of the invention. In certain embodiments, the client system 200 is similar to one of the client systems 110, 120, 130, 140 and 150 of the computing system 100 of FIG. 1.

As illustrated, the client system 200 comprises a server communication module 210, a user interaction module 220, and a determination module 230. In certain embodiments, the server communication module 210 facilitates communication between the client system 200 and the server system 160. For instance, the server communication module 210 can forward information regarding user requests to the server system 160. In certain embodiments, the server communication module 210 can be configured to communicate with the server system 160 via XML.

For example, an XML communication from the server communication module 210 to the server system 160 can include, in certain embodiments, one or more of the following sets of information: interactive character Uniform Resource Identifier (URI) (the URI to which the server system 160 sends responses for the interactive character 190); interactive character identification (different interactive characters 190 can have different capabilities and abilities to perform different action sequences); request type (in certain embodiments, the client system 200 can filter some request types such as search, action request, information); current location (for example, for use in context sensitive requests for information or searches, such as the server system 160 providing information pertinent to the physical location of the user); request text; and interactive character version.

In certain embodiments, the server communication module 210 further receives commands from the server system 160 for controlling the interactive character 190. For example, such commands can be encapsulated in an XML document that includes one or more of the following sets of information in response to a user request: display emotion (the interactive character 190 displays a specific emotion as determined by a state attribute for a time span specified by a time attribute); perform animation (the interactive character 190 performs a custom animation that is specified by executing an animation file); return to previous state (returns the interactive character 190 to the state prior to the start of the animation sequence); return to default state; open browser; open application; return search results; and return information (return information pertinent to the user request and/or the interactive character location).

The illustrated user interaction module 220 further includes a display module 225 configured to control the display of the virtual character 190 to the user and/or to receive and respond to user requests. For instance, the user interaction module 220 can be configured to animate the interactive character 190, display emotions and/or graphics, and/or collect user input.

In certain embodiments, the determination module 230 of the client system 200 receives requests from the user interaction module 220 and attempts to respond to the user's request based on information stored in the database 235. For instance, the database 235 can comprise data for controlling the actions of the interactive character 190. In certain embodiments, the database 235 stores one or more XML documents that provide specific configuration information to generate an instance of the interactive character 190.

For example, when an instance of the interactive character 190 is to be created, the client system 200 can access an appropriate XML configuration file in the database 235. An example of such a configuration file can include the following information: default emotion state (specifies the default emotional state of the interactive character 190 when not performing tasks); default character (specifies among specific characters, the default character presentation of the interactive character 190 upon startup); volume (the volume level of the interactive character 190 upon startup); sound (determine whether sound is used or not used with the interactive character 190); and server location (the URI of the server system 160 for communication between the client system 200 and the server system 160).

In certain embodiments, if the relevant information for responding to the user request is not contained in the database 235, the determination module 230 notifies the server communication module 210, which subsequently communicates with the server system 160 and/or the staff system 170 to obtain the requested information.

It is recognized that a variety of client systems can be used with embodiments of the invention and that FIG. 2 illustrates one embodiment of a client system. For example, in some embodiments, the client system 200 does not include a determination module 230 but instead communicates with the server system 160 whenever the client system 200 receives a request. In other embodiments, the user interaction module 220 and the determination module 230 are implemented as a single module.

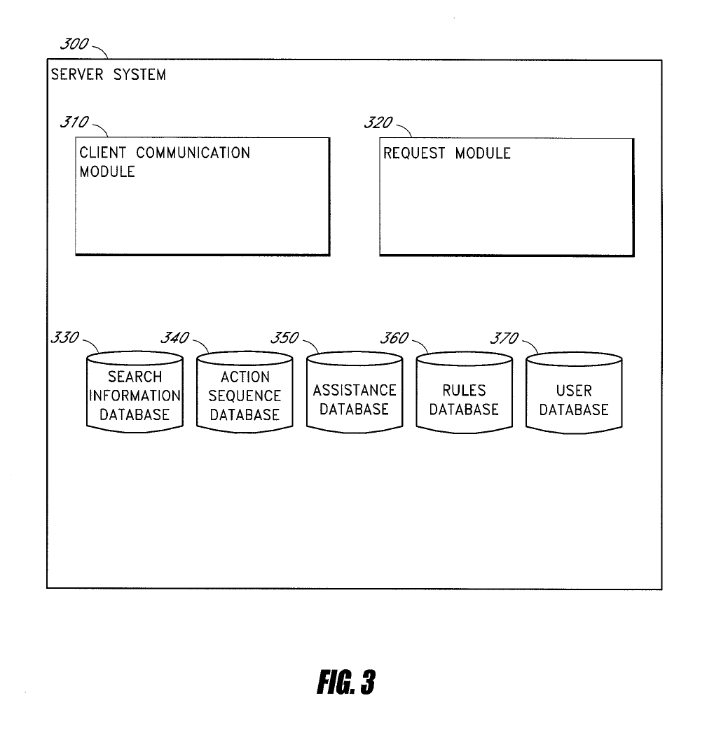

FIG. 3 illustrates a block diagram of further details of a server system 300, according to certain embodiments of the invention. In certain embodiments, the server system 300 has similar functions and/or structure as the server system 160 of the computing system 100 of FIG. 1.

The illustrated server system 300 includes a user system communication module 310, a request module 320, a search information database 330, an action sequence database 340, an assistance database 350, a rules database 360, and a user database 370.

In certain embodiments, the client communication module 310 facilitates communication between the client system 200 and the server system 160. The request module 320 receives requests from the client communication module 310 and processes the requests, such as, for example, by querying one or more of the search information database 330, the action sequence database 340, the assistance database 350, the rules database 360, and the user database 370. In addition, the request module 320 can query the user database 370 to determine the user's goals and/or personality data to present a response to the user request in a manner that promotes the user's goals and conforms with the user's personality data.

For example, in certain embodiments, the request module 320 is configured to utilize natural language processing to process the user requests and/or queries sent from the client system 200. For example, the request module 320 can be configured to receive textual requests and employ comparison algorithms to match the incoming requests with requests stored in the server database(s). In certain embodiments, the request module 320 can be further configured to assign a weighting factor that indicates how well the incoming request matches one or more stored requests. Moreover, in such embodiments, users can have the option to set a threshold of how well requests are matched before a response is considered suitable.

In certain embodiments, the request module 320 can catalog each incoming request based on predetermined classes of actions, which can correspond to the various databases of the server system 300. For example, the illustrated request module 320 can be configured to identify requests that fall into one of the three following categories: search requests, action requests and assistance requests. A “search request” can be a request to find information, such as using existing search engines to identify desired data. An “action request” can be a request from the user that the interactive character 190 perform a specific action (for example, “swim like a fish”). An “assistance request” can represent a question by a user that requires a specific answer (for example, “What aisle is peanut butter on?” or “Why is the sky blue?”). After categorizing a request, the request module 320 can access the appropriate database(s) (for example, the search information database 330, the action sequence database 340, or the assistance database 350) to generate a response to be sent to the client system 200.

In certain embodiments, a response is sent from the server system 300 to the client system 200 via the client communication module 310 in an XML format. For example, a response can have one or more of the following types of information: “response found” notification (notifies the client system 200 if a response was found within the stored responses); response level (a measurement (weighting) of how close the response matches one or more stored responses within the server databases); action sequence (an XML action sequence to be performed by the interactive character 190); graphics URI (URI of graphics and/or animations necessary to perform the action sequences); and confirmation request (request for confirmation from client/user of correctness and/or sufficiency of response).

Although the server system 300 has been described with reference to particular arrangements, other embodiments of the invention can include different arrangements. For example, one or more of the databases 330, 340, 350, 360 and 370 can be located at a remote location with respect to the server system 300 and/or can be combined or subdivided into additional databases. Moreover, in certain embodiments, the server system 300 can communicate at least a portion of the database information for storage on one or more client devices.

Moreover, in certain embodiments, one or more of the server databases can comprise information compiled through a collective intelligence process that utilizes a collection of user requests and associated answers to generate the information. In certain embodiments, the information includes a hierarchy of responses associated with different personality types.

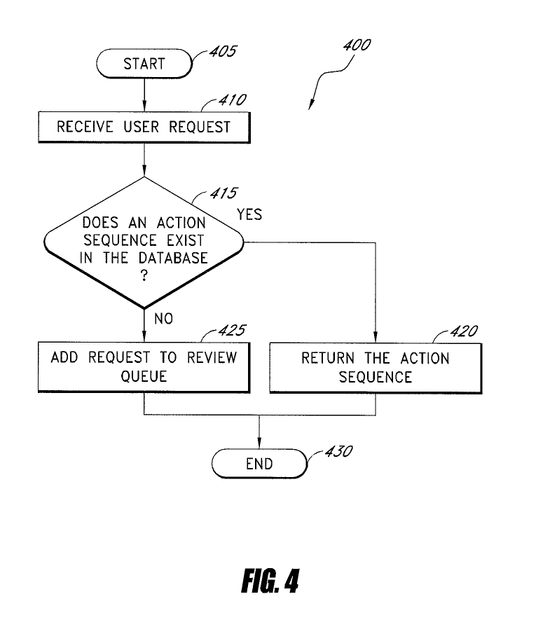

FIG. 4 illustrates a flowchart of a method 400 for processing user requests usable with the computer system 100 of FIG. 1. In certain embodiments, the method 400 can be executed by one or more of the client systems 110, 120, 130, 140, 150 of FIG. 1 or the client system 200 of FIG. 2. For exemplary purposes, the method 400 will be described with reference to the components of the client system 200.

As shown in FIG. 4, the method 400 begins at Block 405 and receives a request from a user (Block 410). In certain embodiments, the user request can comprise a search query, a question, a command, combinations of the same or the like.

The method 400 then determines whether or not an action sequence exists in the client system database 235 (Block 415) that corresponds to the user request. For example, if the user request is for the interactive character 190 to perform a particular action (such as, swim like a fish) or function (such as, execute a search query), the action sequence can comprise instructions for executing the requested action or function. If the appropriate action sequence exists in the database 235, the method 400 returns the action sequence (Block 425) for execution by the interactive character 190 and proceeds to the end state (Block 430)

On the other hand, if the action sequence does not exist in the database 235, the method 400 sends a request for the action sequence to a staff queue (Block 420) and proceeds to the end state (Block 430). The staff queue, for example, can be located on a server system or other computing device through which designated personnel can review pending user requests.

It is recognized that other embodiments of the method 400 can be used. For example, the method 400 can receive other requests for information that may be stored on the client system 200 and/or a server system 160, whereas in other embodiments, only action sequence information is stored on the client system 200. Moreover, the method 400 can comprise instructions executable by one or more processors of one or more computers for performing the various blocks. In certain embodiments, such instructions are stored on a computer-readable medium.

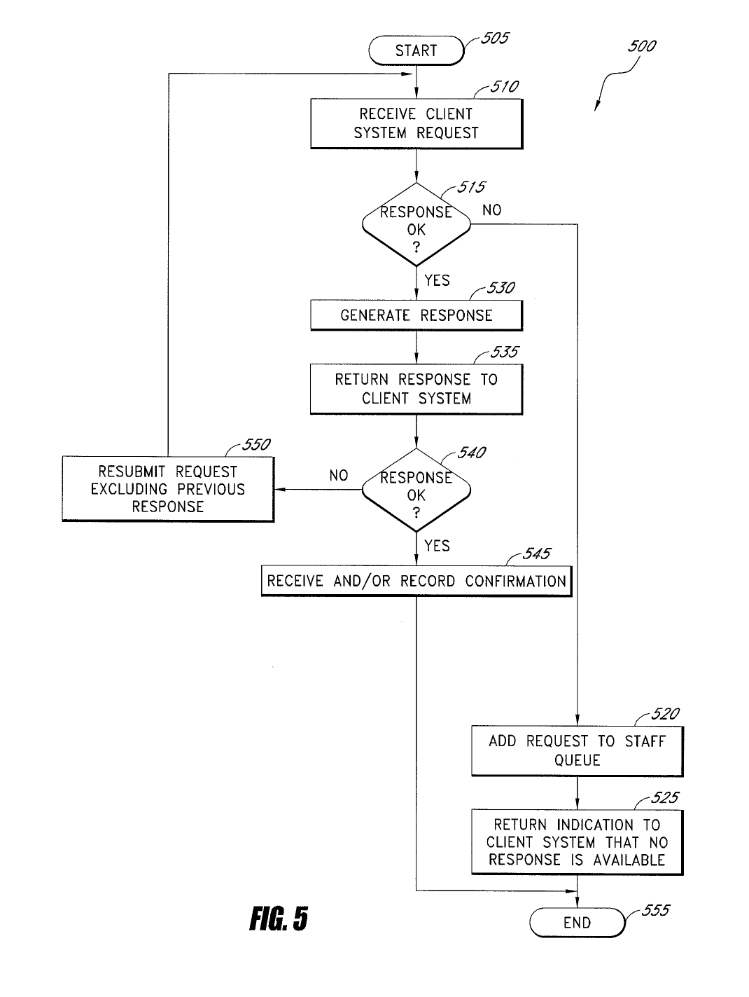

FIG. 5 illustrates a flowchart of an embodiment of a server method 500 for processing user requests. In certain embodiments, the server method 500 can be executed by one or more server computers, such as the server system 160 of FIG. 1 or the server system 300 of FIG. 3. For exemplary purposes, the method 500 will be described with reference to the components of the server system 300.

As shown, beginning at a start state (Block 505) of the method 500, the server system 300 receives a user request from a client system (Block 510). In certain embodiments, the request comprises a search query, a question, a command, combinations of the same or the like.

The server system 300 then determines whether or not it can provide a response to the user request (Block 515). For example, the request module 320 of the server system 300 can access one or more databases to determine if a response stored therein corresponds to the user request. If not, the server system 300 sends the request to a staff queue (Block 520) and returns an indication to the requesting client system that a response is not currently available (Block 525).

If, on the other hand, the server system 300 can provide a response to the client system request, the server system 300 generates a response (Block 530) and returns the response to the client system (Block 535). At Block 540, the method 500 determines if the response is sufficient to meet the parameters of the user request or query. For example, Block 540 can include providing the response to the user and asking the user to indicate whether or not the response answers his or her question. If the response is sufficient (for example, the server system 300 receives a user confirmation from the client system), the method 500 proceeds with receiving and/or recording the confirmation (Block 545) and proceeds to the end state (Block 555).

If, however, the response is not sufficient, the method 500 resubmits the user request to the server system 300 while excluding the previous response(s) (Block 550).

Although the method 500 has been described with reference to a particular arrangement, other embodiments of the server processing method 500 can be used. For instance, the method 500 can advantageously receive and/or record an indication from a user that a selected response was not sufficient (prior to or concurrently with Block 550). In such embodiments, both “yes” and “no” feedback from the user as to the sufficiency of a selected response can be analyzed, stored and/or otherwise used in subsequent situations wherein a similar request is made to the server system 300. For instance, if a user indicates that a response was not sufficient (such as through specific input and/or by not heeding a suggested action), the server system 300 can note that the particular response is not appropriate for similar requests from others of the same or similar personality type and/or having the same or similar goals.

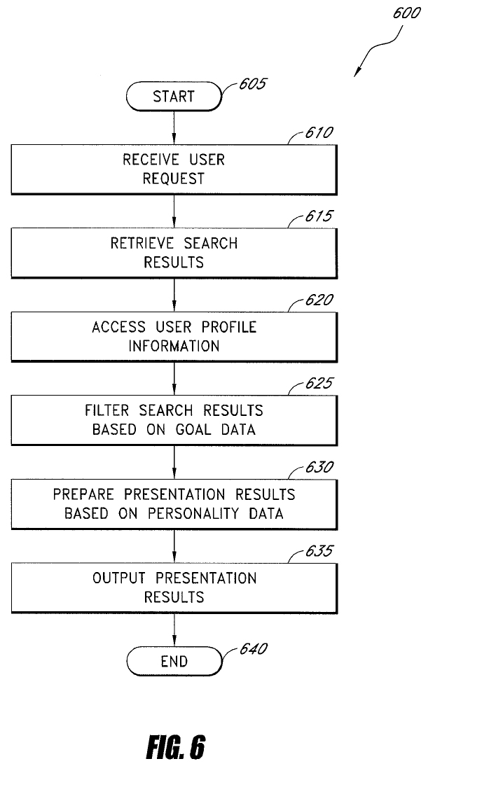

FIG. 6 illustrates a flowchart of an exemplary embodiment of a method 600 for personalizing responses to a user request, according to certain embodiments of the invention. In certain embodiments, the method 600 is a computer-executable method that can be performed by the computer system 100 of FIG. 1.

The method 600 begins at a start state (Block 605) and receives a user request (Block 610). At Block 615, the method 600 retrieves a plurality of results based, at least in part, on the user request. For instance, in the situation where a user request comprises a search request, the method 600 can retrieve a plurality of search results. In certain embodiments, retrieving the search results is performed using available search engines and/or technologies.

At Block 620, the method 600 includes accessing user profile information. For instance, the user profile information can comprise information regarding preferences, goals, character, personality, habits, choices, action history, relationships, or the like of a particular user. Such user profile information can be stored locally on a client system and/or can be stored on a server system (such as in the user database 370). For instance, a primary copy of the user profile information can be stored in a central location (for example, a server system), while secondary copies are maintained at one or more client systems. In such embodiments, updates to the user profile information can be sent to the server system and then forwarded to one or more client systems.

In certain embodiments, the user profile information advantageously includes goal data specific to the user. In certain embodiments, the goal data is indicative of aspirations, goals, targets, preferences or the like that have been communicated to the computer system (for example, by the user through one or more client systems). For instance, goal data for a particular individual can comprise a desire to exercise, to save money, and/or to avoid eating certain types of foods. In certain embodiments, the goal data can be periodically updated by the user. In other embodiments, the goal data may reflect the goal(s) of a plurality of members of a group. For example, a group of individuals, which includes the user, may have a goal to exercise more often. This information can then be added to the user profile information.

With continued reference to FIG. 6, at Block 625, the method 600 filters the search results based, at least in part, on the goal data received from the user profile information. For instance, if a user request concerns the identification of nearby restaurants, and the user goal data indicates that the user is trying to lose weight, the method 600 can filter the search results to: (i) remove names of restaurants that typically serve high-calorie and/or fattening foods, and/or (ii) highlight those restaurants that generally have healthy menus.

In yet other embodiments, such filtering at Block 625 may include ordering search results based on the goal data rather than removing search results. For instance, search results that are consistent with the goal data can be moved to the top of the search results list and/or can be highlighted or otherwise identified for easier detection by the user.

The method 600 continues with Block 630 to prepare presentation results based, at least in part, on personality data. In certain embodiments, personality data comprises information that reflects the personality of the interactive character 190, such as in its communication and/or interaction with the user. For example, a user can set a default preference indicative of how he or she would like the interactive character 190 to act. For instance, the user can choose the interactive character 190 to be aggressive, passive, humorous, robotic, dramatic, combinations of the same or the like. In certain embodiments, such selections can be made in degrees (for example, level-9 aggressive and level-3 humorous) and are stored on the server computer and/or locally on the client system. In other embodiments, the computer system 100 can automatically choose a personality for the interactive character 190 based on the user's personality. For instance, the computer system 100 may access results of a personality test provided to a user and select a personality for the interactive character 190 that complements the personality of the user.

In certain embodiments, the personality data can reflect specific characteristics of the user. For example, personality data can indicate that a particular individual is reserved, aggressive, self-motivated, humorous, detail-oriented, thoughtful or the like.

In certain embodiments, the preparation of the presentation results in Block 630 includes generating the textual context in which the presentation results are to be provided to the user. For instance, if a user has selected an “aggressive” personality for its interactive character 190, the textual context of the presentation results can include a harsh or demanding tone.

For example, if a user requests a list of nearby steakhouses, but his goal data indicates he is trying to eat less red meat, an aggressive interactive character 190 can scold or otherwise inform the user that he should not be interested in steakhouses. However, if the user has selected a gentle personality for his interactive character 190, the textual context of the presentation results can include a nice reminder that the user is trying to avoid red meat and may provide alternative options for nearby restaurants.

Although Block 630 has been described with reference to particular embodiments, other types and forms of presentation results can be used. For example, in other embodiments, preparation of the presentation results based on personality data of the interactive character 190 can include customizing actions or recommendations by the interactive character 190 (for example, automatically making a reservation or purchasing an item), adjusting the audio or voice characteristics of the interactive character 190, further filtering the search results, providing one of a plurality of virtual characters, combinations of the same or the like.

Moreover, in certain embodiments, the method 600 can process user requests other than search requests. For example, Blocks 615-630 can comprise processing user-defined actions, questions by the user, suggestions or comments by the interactive character 190, combinations of the same or the like.

At Block 635, the method 600 outputs the presentation results, such as to a display, to be presented to a user by the interactive character 190. The method 600 then terminates (Block 640).

The following disclosure provides specific non-limiting examples of embodiments of the invention. In particular, examples are disclosed of a virtual character (sometimes referred to hereinafter as a “miMuse”) for providing customized and/or personalized interaction with a user or owner. In certain embodiments, the virtual character can represent the interactive character 190 of FIG. 1.

In certain embodiments, the virtual character advantageously comprises human-like features. In yet other embodiments, the character may be in the form of an animal (for example, a dog, cat, horse or the like), a robot, an animated object, a toy, a vehicle, combinations of the same or the like.

In some embodiments, the virtual character advantageously “knows” the user by interacting with the user and learning about the user's characteristics, preferences, personality, goals, habits, styles, schedule, favorite places and things, special occasion days (for example, birthday, parents' anniversary, nephew's graduation, best friend's birthday, and so forth), physical health, emotional health, and/or routines. The virtual character is advantageously designed to understand, guide, encourage, love, provide reminders to the user, and/or help the user attain the user's goals.

In some embodiments, the virtual character is capable of “learning” new information. If asked a question by the user, the virtual character may answer the question or request information about the question from another source (for example, a server system), and when a response is obtained, answer the question and store the response information. In some embodiments, the knowledge “learned” by a virtual character may be stored in a shared database in conjunction with knowledge “learned” by other virtual characters such that a virtual character may have access to its own knowledge as well as to the knowledge of other virtual characters. In certain embodiments, the virtual character can gather knowledge through artificial intelligence algorithms and/or by monitoring browsing habits, past choices or the like by the user or by individuals with similar characteristics to the user.

In certain embodiments, the virtual character can take into account the user's goals when interacting with the user. For example, if the user is a diabetic trying to avoid eating sugar and the user searches for “restaurants,” the virtual character may present the user with a listing of restaurants within a ten-mile radius of the user's home (knowing that the user does not like to drive too far for dinner) that have a large selection of sugar-free desserts (knowing that the user enjoys desserts but also wants to stick to his or her goal). As another example, if the user is trying to lose weight and the user searches for “weekend events,” the virtual character may present the user with a list of yoga classes, softball games, Sierra Club hikes, and golf lessons as the top search results such that the top results would be activities that promote the user's goals.

In some embodiments, one or more traits of the virtual character may be customized by the user. For example, the user may determine how she or he would like the virtual character to look, act, talk, and/or socialize. For example, the user may customize the appearance and/or clothing of the virtual character. In further embodiments, the user may customize the lifestyle, personality, language, and/or interactive style of the virtual character.

In addition, the virtual character can advantageously be designed to interact in a manner that relates to the personality of the user. For example, if a user, who is on a diet, is ordering online groceries, the user's virtual character can interact with a user in a very blunt manner using a dry sense of humor, indicating to the user, “I took all of those candy bars out of your online shopping cart because they are just love handles waiting to happen.” For another user in the same situation, the user's virtual character may interact with the user in a kind, soft spoken manner, indicating to the user, “I know you really like those candy bars, but I know that you have also been trying so hard to lose weight. How about some dried apricots or a mixed package of nuts instead?”

As disclosed herein, in certain embodiments, the virtual character interacts with the user based on information stored in one or more databases (for example, a database of the server system 160). Such information can be advantageously gathered through collective intelligence technology, wherein past user questions, associated responses, and user feedback are used to generate a hierarchy of responses associated with different personality types. For example, responses can be customized, at least in part, to a particular user based on the user's personality by using similar responses that were successful in previous questions from others users with the same or similar personality.

In particular, the user information for a certain individual can be compared to data and response histories compiled with respect to other individuals with the same or similar personality traits. For example, if Jill has a goal to lose weight, the virtual character can notify Jill of a new night aerobics class at a small local women's gym because Jill's user information indicates that she is a shy person that works during the day and that has little time for extra activities. On the other hand, Amy, who has the same goal to lose weight, can be recommended by her virtual character to apply for a year membership at a popular fitness center because Amy's user information indicates that she is outgoing, likes to socialize with others and is committed to achieving long term goals.

In some embodiments, one of the objectives of the virtual character is to encourage and/or facilitate the user's participation in “real world” activities (as opposed to sitting in front of a computer or television screen) and socializing with other people, places and businesses (such as, for example, entertainment, retail, social experiences, events, restaurants or the like). For example, if the virtual character alerts the user that it is the user's nephew's birthday, the virtual character may recommend that the user take her nephew out to dinner. As another example, the virtual character may recommend that the user take the nephew to MAGIQUEST, an interactive play facility offered by Creative Kingdoms. As a further example, if the user wants to download a new movie to watch at home, the virtual character can encourage the user to go to the showing of “Breakfast at Tiffany's” at the local independent film theater (knowing that the user enjoys Audrey Hepburn movies and is getting ready for a trip to New York City).

In some embodiments, the virtual character is configured to perform a wide variety of functions and/or activities. For example, in some embodiments, the virtual character may perform one or more of the following:
Synchronize with MICROSOFT OUTLOOK or other scheduling program to determine and keep track of appointments, deadlines, homework due dates, social events, birthdays, medication schedules, anniversaries, vacations, holidays, dates, bills, combinations of the same and the like;
Synchronize with MapQuest or other mapping program to keep track of locations of specific venues and/or destinations;
Conduct and or receive results from a user personality test or emotional intelligence questionnaire;
Respond to social interactions;
Learn the user's likes and dislikes and cater interactions accordingly;
Allow the user to input her feelings, thoughts, goals, ideas, needs and/or life events and interact accordingly;
Match the user's personality to opportunities in the virtual and real world;
Provide online searching capability (for example, automatically) based on needs, habits and/or characteristics of the user;
Suggest to the user places to visit (for example, concerts, stores, restaurants) based on user preferences;
Play games (for example, fun facts, brainteasers, riddles);
Earn or award points when the user achieves and/or follows through with a “quest;” for instance, such points may be used by the user to obtain one or more rewards (such as, for example, retail items, vacations, airline miles, combinations of the same or the like);
Connect the user with friends, family and social experiences of interest to the user;
Accompany the user on trips, excursions, or events and/or provide related advice, tips, specials (such as discounts) or the like;
Provide a messaging service between virtual characters and/or their users;
Provide holograms (for example, of the virtual character);
Synchronizing with an IPOD and/or notify the user of songs and/or music he or she may like;
Synchronize with EBay items the user may have an interest in;
Synchronize with Amazon.com for books the user may have an interest in;
Synchronize with charitable organizations for gifting and giving;
Synchronize with a Hallmark database for birthday reminders;
Synchronize with educational facilities for learning tips; and/or
Synchronize with MAGIQUEST or other live entertainment facilities.
   It is recognized that the virtual character may perform many types of functions and/or may be limited to certain functions or types of functions. Moreover, the virtual character may perform different functions than those listed above.

In some embodiments, the goals followed by the virtual character may relate to an individual and/or may relate to a group of users. For example, a virtual character may be created for: a group of young professional singles wanting to start an investment club, a group of users researching the lineage of the “McFarland” family name; a group of users researching cures for breast cancer; a group of parents searching for help in dealing with autism; a group of students that attend the same high school; a group of coworkers that are working at the same company and so forth. In some embodiments, a virtual character may relate to one set of goals, whereas in other embodiments, a virtual character may relate to more than one set of goals.

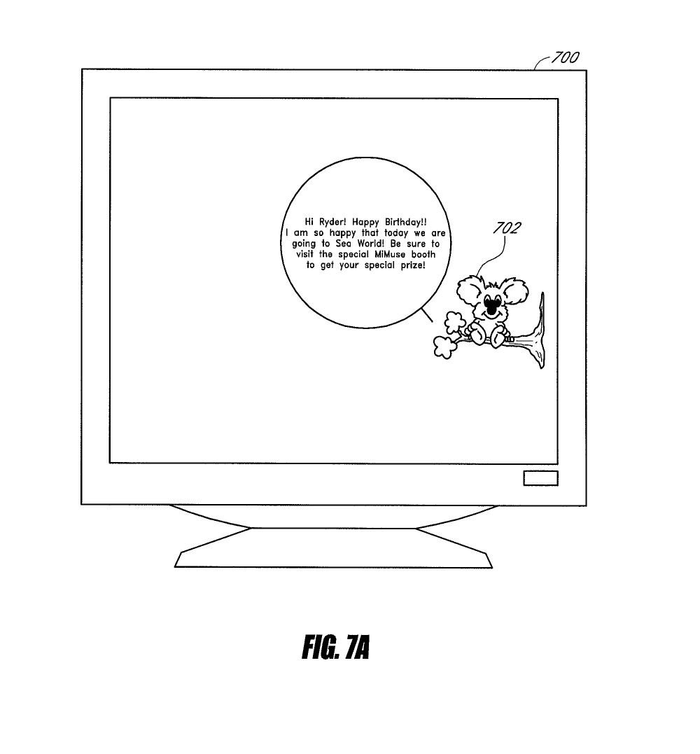

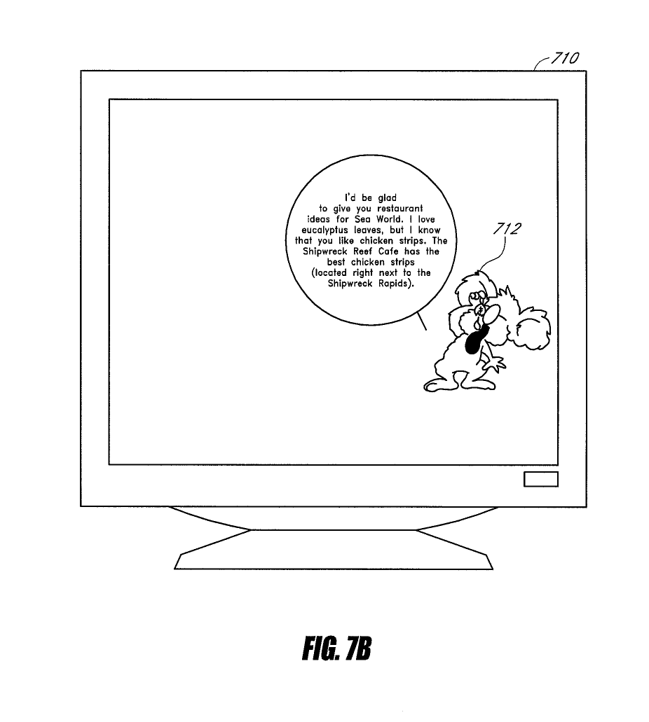

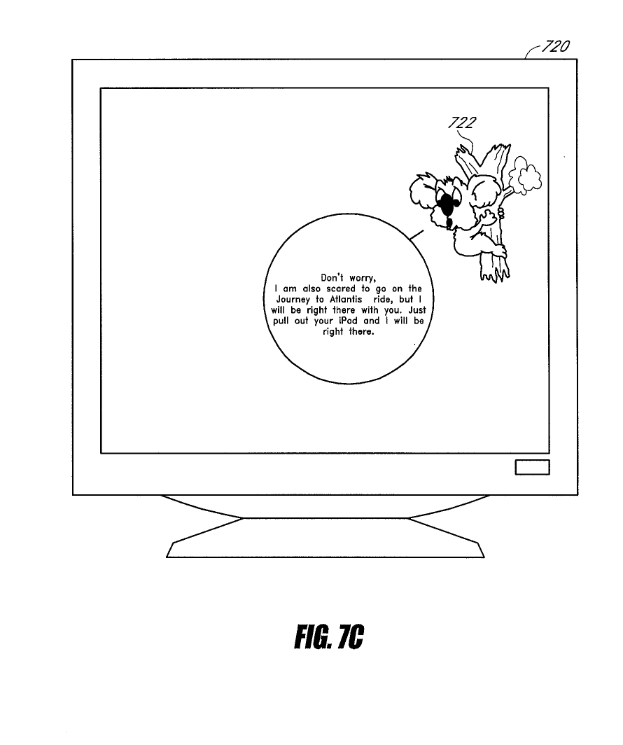

FIGS. 7A-7C illustrate exemplary embodiments of a computer screen display including an interactive character, or miMuse, for a little boy named Ryder, who is turning four years old. For instance, in certain embodiments, the computer screen display may correspond to the display 180 of the client system 110 of the computer system 100 of FIG. 1.

As shown in FIG. 7A, a display 700 shows that Ryder's miMuse 702 is very positive and excited about Ryder's birthday and his upcoming trip to SEA WORLD. Moreover, Ryder's miMuse 702 encourages him to visit the miMuse booth (which may include, for example, a kiosk) at SEA WORLD to get a special prize.

In FIG. 7B, a display 710 shows Ryder's miMuse 712 eating a leaf and giving Ryder restaurant recommendations knowing that Ryder really likes chicken strips. FIG. 7C further illustrates a display 720 with Ryder's miMuse 722 encouraging Ryder to go on a ride that Ryder is frightened of and reminding Ryder that the miMuse 722 will be with Ryder on the ride via Ryder's iPod.

As can be seen from FIGS. 7A-7C, Ryder's miMuse provides positive and encouraging comments to Ryder. This can be especially helpful for small children who may have fears of specific activities.

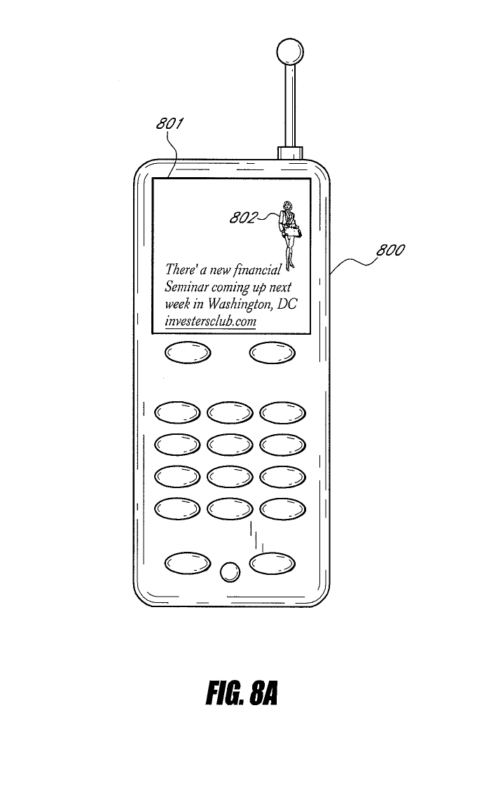

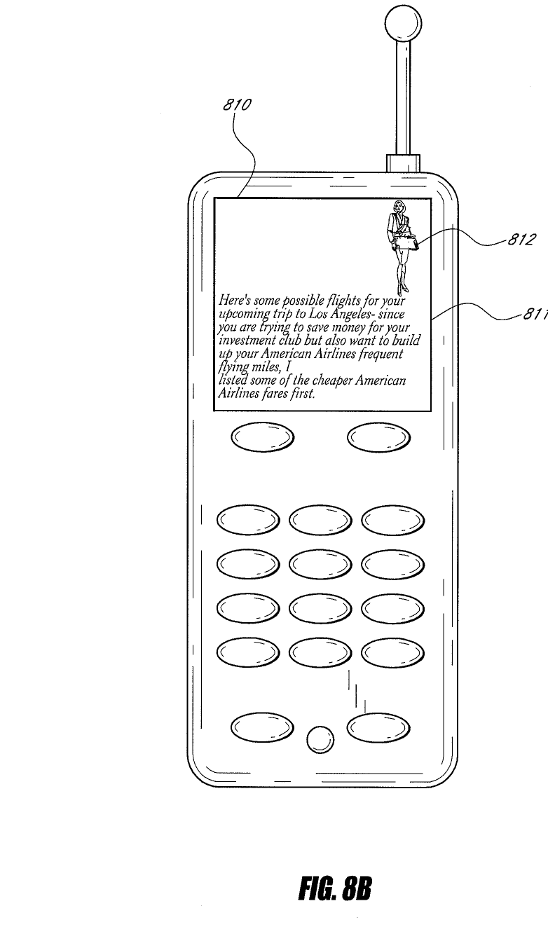

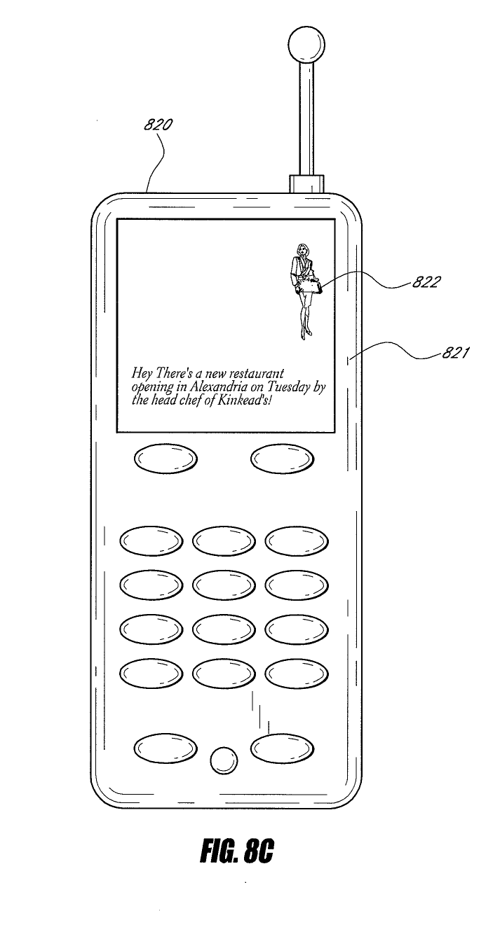

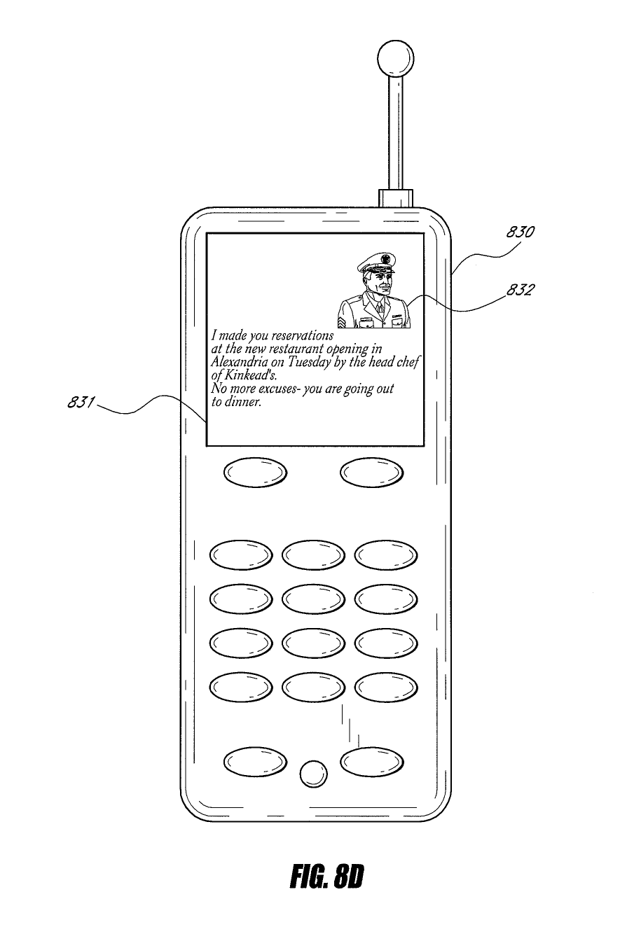

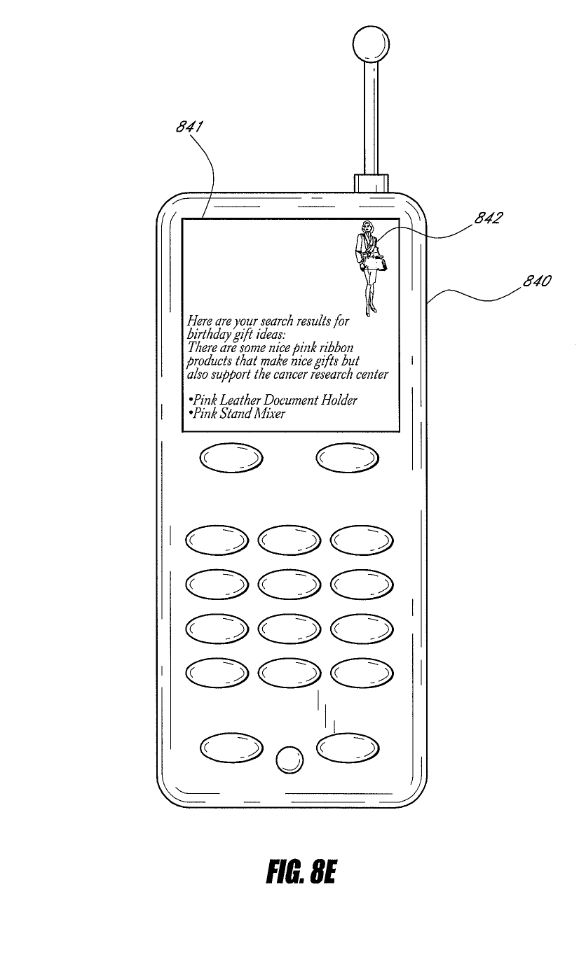

FIGS. 8A-8E illustrate exemplary embodiments of a cell phone device providing suggestions and/or information through a miMuse. In particular, FIGS. 8A-8C and 8E include representations of a miMuse for a woman named Josie. Josie's miMuse provides responses and/or suggestions in response to user profile information that indicates:
1. Josie is interested in increasing her investment knowledge;
2. Josie has a goal to save money;
3. One of Josie's goals is to increase her AMERICAN AIRLINES frequent flier mileage account;
4. Josie lives in Arlington County;
5. Josie is a member of a restaurant review group; and
6. Josie is interested in supporting breast cancer research.

FIG. 8A illustrates a cell phone 800 with a display 801 showing Josie's miMuse 802 informing her that there is a new financial seminar coming up near Josie's home and provides Josie with a link to sign up for the seminar. FIG. 8B illustrates a cell phone 810 with a display 811 showing Josie's miMuse 812 providing flight information for the cheapest AMERICAN AIRLINES flights in response to a search by Josie for airline tickets.

FIG. 8C illustrates a cell phone 820 with a display 821 showing Josie's miMuse 822 telling Josie and other members of her restaurant review group about the opening of a new restaurant near her home. FIG. 8D illustrates a cell phone 830 having a display 831 showing a miMuse 832 of Mark, another member of Josie's restaurant review group. Because Mark has a more forceful personality and wants his miMuse to push him to be active, Mark's miMuse 832 has already made a reservation at the restaurant opening and sent a message to Mark that he needs to be more proactive and must go to the opening.

FIG. 8E illustrates a cell phone 840 with a display 841 showing Josie's miMuse 842 providing Josie with search results for a birthday gift. Because Josie is interested in supporting breast cancer research, the top gift ideas presented are for products for which the seller contributes some of the sale proceeds to breast cancer research.

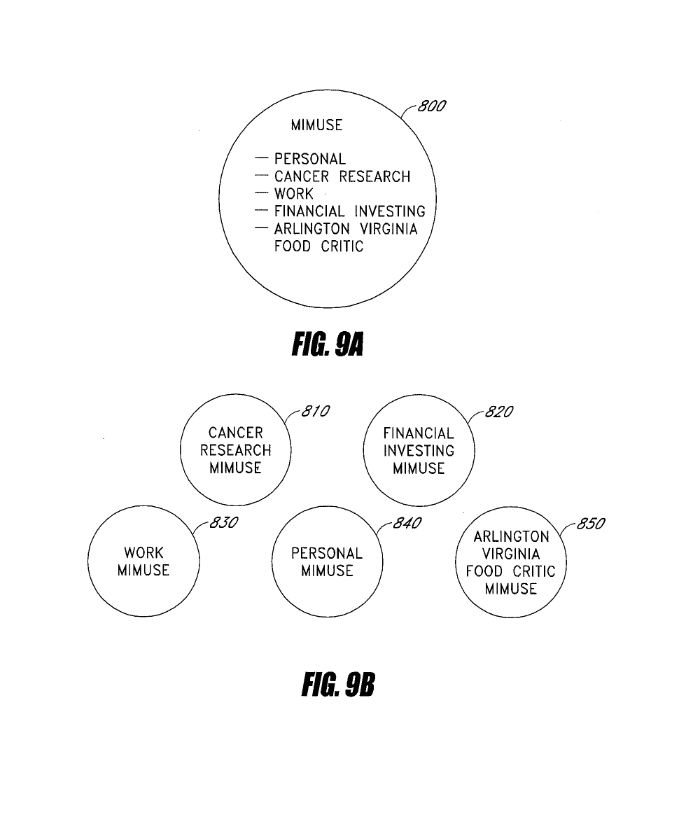

FIGS. 9A and 9B illustrate exemplary embodiments of user profile information that has been assigned to one or more virtual characters for interaction with a user. In particular, FIG. 9A illustrates a set of user profile data that has been associated with a single miMuse. As shown, when responding to user requests and/or providing information to a user, a single MiMuse can consider the user's personal goals, as well as goals related to cancer research, work, financial investing, and dining options in the user's residential area.

FIG. 8B illustrates the same user being associated with multiple miMuses, wherein different sets of user profile information have been assigned to different miMuses. In particular, FIG. 8B illustrates a cancer research miMuse 810, a financial investing miMuse 820, a work miMuse 830, a personal miMuse 840 and an Arlington Va. Food Critic miMuse 850.

In certain embodiments, the character represented by each miMuse is customized to the user profile information to which the miMuse has been assigned. For example, the cancer research miMuse 810 can be a nurse character, whereas the financial investing miMuse 820 can be sponsored by the Buffett Foundation and have a caricature of Warren Buffett. In other embodiments, the miMuse can take on the form of a variety of other licensed characters. Moreover, in certain embodiments, the visual representation of the miMuse can advantageously be stored on the client system as is independent of the server system architecture.

In certain embodiments, the virtual character can also be part of a virtual community and/or associate with other virtual characters. For instance, in some embodiments, the virtual character may be part of an interactive community in which one or more users are able to select and/or customize a neighborhood and/or housing for the virtual character. In yet other embodiments, virtual characters can be capable of communicating with each other via instant messaging or other like communications (such as one virtual character alerting another virtual character that a special event is to occur).

In some embodiments, a virtual neighborhood can include sponsors (such as, for example, restaurants, stores, or the like) having locations within the neighborhood that may be visited by the virtual character (and his/her user). In some embodiments, a user and/or virtual character may interact with other virtual characters by sharing a “brag book” (such as an online album or profile) of the user. In some embodiments of the invention, a website may be provided that offers for sale one or more virtual characters, a professional help resource, specialized services (for example, dating, job hunting, vacation planning, charities, referral services), combinations of the same or the like. In some embodiments, the website may be associated with a database that identifies a plurality of virtual characters that may be matched with each other and/or with particular service providers (such as those who pay to be associated with the website).

Moreover, in certain embodiments, the miMuse can be part of a reward-based system sponsored by one or more companies. For example, the more loyal a user is in visiting a specific retailer, purchasing items recommended by miMuses, meeting goals, and/or accomplishing quests, the owner of the miMuse can earn reward points. These reward points can then be used for purchasing particular items and/or services.

In addition, retailers, entertainment facilities, travel industry, and like entities can have specials for miMuses. Such advertising can include rewards, tips, discounts, combinations of the same or the like. Moreover, when the user brings his or her miMuse to a sponsoring entity, the user can receive a particular award. For example, if a child brings his miMuse to MCDONALDS, he can then download a character or tip that he can subsequently use in a website game.

Although systems and methods of a miMuse system are disclosed with reference to certain embodiments, the invention is not intended to be limited by such embodiments. Rather, a skilled artisan will recognize from the disclosure herein a wide number of alternatives for the implementation of the described systems as well as the ordering of the flowcharts.

For instance, the following provides several non-limiting examples of a variety of functions and/or activities that can be associated with embodiments of a miMuse system:
Professional research and proven emotionally sophisticated personality tests can be given (for example, in an entertaining way) to the user by the miMuse system to initiate the process of “learning” the user and/or beginning the process of selecting methods for supporting the user's needs, goals, and overall “connection.” This test can be used to customize the miMuse's responses, knowledge and/or understandings of the user.
The miMuse system can be connected to a user's playlists on an MP3 player and/or ITUNES. As part of a personality test, the miMuse can ask the user about favorite music or songs he or she likes to listen to while exercising, while studying, for romance, for motivation, while sleeping, to wake up, and so forth. Such data can be stored and/or used to support the user.
The miMuse system can be connected to a television, and the virtual character can appear on the television screen. The miMuse can select television listings, TIVO and other television/cable programming that the user may want to watch as a part of goal setting.
The miMuse can be connected to an online auction system and detect unique items that come up for auction that the user may want.
One or more miMuses can be created for a group, company or family for collaborative goals. For example, a company can create a miMuse that the employees interact with and that has yearly goals. The miMuse can be shared between employees and management in sharing collaborative goals and allowing individuals to be aware of the company's mission, growth plans, etc. The miMuse can “live” on the company's computer network and interact with the employees to support overall goals. Families can also have collaborative miMuses to work with them on family goals, saving for vacation, growing a garden and/or planning a family reunion.
Charity organizations can have a charity miMuse that helps the organization reach its goals. This miMuse can be crossed between other company and group miMuses. In such embodiments, private information can be protected or removed. Consumers can peek into the miMuses of companies to see what kind of mission statement and goals it has set up and/or the culture of the company.
The miMuse can be a part of a virtual world that is generally active. The miMuse can be programmed to be “open” to allow other miMuses to visit. Other miMuses can be added to a friend list, and these miMuses can visit other miMuses' homes, post messages, make suggestions, or the like. MiMuses not on the friend list, but have similar goals (for example, interested in charitable organizations), can be asked to join a common campaign or group. The miMuse can seek other miMuses while in hibernation in the virtual world, and when the miMuse is awakened the next day, it can have a list of other miMuses interested in joining the campaign. The virtual world can appear like a FACEBOOK or MYSPACE page. This page can be customized to reflect the miMuse's personality.
The miMuse can be programmed to receive special training or be educated in something with which the user is not familiar. The miMuse can learn how to perform an activity and can report back on to the user. For example, a user who wants to learn how to rock climb can send his or her miMuse to learn how to rock climb.
The miMuse can be a specialist one or more areas. For example, a miMuse specializing in golf can provide a user/owner with tips, stories, and/or recommendations relating to the game of golf and/or notify the user of current golf events or news.
The miMuse can receive all kinds of items to put in its virtual world. There can also be special training programs that a user can pay for from online universities, etc. These special programs can take the information from a specific training university, program, etc., and then customize the information for the user in a way he or she best learns. For example, the user can purchase a writing program for the miMuse to learn and then teach back to the user in a personalized manner.
Master miMuses and/or miMuse trainer programs can be provided in which a business pays for a special program to create a miMuse that advertises or expresses a business to the public. For example, a miMuse can be developed that trains or gives tips on filing tax returns.
The miMuse can be programmed to seek a Top Ten list, such as, for example, movies, songs, YOUTUBE videos, stocks, combinations of the same or the like.
The miMuse can be told to be quiet, go away, leave the user alone at any point in time, and/or can return only when asked.
A Mega Muse can be a Master miMuse that multiple users can access for information on a specific talent, issue, knowledge, etc. For example, there can be a Master Muse of Weight Loss, Master Muse of Colleges and Universities, etc. The user can access these Mega Muses without intervention by personal miMuses.
Special miMuse events (e.g., paid events) can allow users to “meet” the miMuses of people they admire (for example, an astronaut, a celebrity).
A miMuse can be purchased for someone with a special need, who needs support, and/or as a gift.
A user can own multiple miMuses, and they can all live in the same “page.”

Various business models can also be utilized with the miMuse system. Some non-limiting examples include:
Online retailers and search engines can license a miMuse database to have access to users and/or give the miMuses suggestions of sites of products or places to “visit.”
Retailers can license the miMuse system to have access to users when they walk into a retail environment. For instance, the retailer can be capable of detecting, triggering and/or making suggestions to the users' miMuses.
Virtual and “brick and mortar” retailers can purchase miMuse connections and programming development to create items for the miMuse, experiences, etc. For example, users can pay for additional and/or special (virtual) items associated with the miMuse.
Health care companies can purchase special miMuses to assist consumers with health issues. For example, miMuses specialized in one or more particular health areas can be used, such as fitness miMuses, weight loss miMuses, high blood pressure miMuses, anti-smoking miMuses, or the like.
MiMuses can be purchased as a package gift that includes retailers' items as well. For example, a wedding planner miMuse can come with books and/or items to help with the wedding planning process. A weight loss miMuse can come with a membership to a health program. A travel miMuse can come with a vacation package. A ZAGOT miMuse that recommends restaurants can come with a discount book or a meal at a particular restaurant. Such miMuses can be preprogrammed by the retailer but can also have the ability to be customized by the user.
MiMuses that are specialists in a particular area (for example, golf, dance, travel) or skill set can be offered to users for a fee.
Companies or businesses can purchase Master Muses and/or training programs to sell their goods or services.
Special miMuses can be purchased that are licensed characters. In certain embodiments, the licensed character can correspond to a particular skill set of the miMuse (for example, a Tiger Woods character for a miMuse specializing in golf).
Special miMuses can be purchased that have additional animation ability.
Devices can be purchased and/or customized to “carry” a miMuse.

Furthermore, in some embodiments, the systems and methods described herein can advantageously be implemented using computer software, hardware, firmware, or any combination of software, hardware, and firmware. In certain embodiments, a system is implemented as a number of software modules that comprise computer executable code for performing the functions described herein. In certain embodiments, the computer-executable code is executed on one or more general purpose computers. However, a skilled artisan will appreciate, in light of this disclosure, that any module that can be implemented using software to be executed on a general purpose computer can also be implemented using a different combination of hardware, software, or firmware. For example, such a module can be implemented completely in hardware using a combination of integrated circuits. Alternatively or additionally, such a module can be implemented completely or partially using specialized computers designed to perform the particular functions described herein rather than by general purpose computers.

It is also recognized that the term “remote” may include data, objects, devices, components, and/or modules not stored locally, that are not accessible via the local bus. Thus, remote data may include a device which is physically stored in the same room and connected to the user's device via a network. In other situations, a remote device may also be located in a separate geographic area, such as, for example, in a different location, country, and so forth.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method for personalizing a response to a user request, the method comprising:
receiving from a user a request for information;
generating a set of search results in response to the user request;
retrieving a user profile, the user profile including both user goal data indicative of one or more goals of the user and personality data;
filtering the set of search results based at least in part on the user goal data;
generating presentation results for presenting one or more responses to the user according to the personality data, the one or more responses comprising at least a portion of the filtered search results; and
returning the presentation results.

2. The method of claim 1, wherein said presenting one or more responses comprises a virtual character presenting the one or more responses.

3. The method of claim 2, wherein generating presentation results comprises selecting a tone of communication of the virtual character.

4. The method of claim 2, wherein said presenting one or more responses comprises a performance of one or more actions by the virtual character.

5. The method of claim 2, wherein the personality data comprises one or more personality traits associated with the virtual character.

6. The method of claim 1, wherein the user request comprises a search query.

7. The method of claim 1, wherein the goal data comprises one or more goals of a group of individuals comprising the user.

8. The method of claim 1, wherein the personality data is indicative of a personality of the user.

9. The method of claim 1, wherein said filtering comprises ordering the set of search results.

10. The method of claim 1, wherein said filtering comprising removing at least a portion of the set of search results.

11. The method of claim 1, additionally comprising receiving a confirmation from the user that at least one of the one or more responses was a satisfactory response to the user request for information.

12. A computing system for personalizing a response to a user request, the computing system comprising:
a client device comprising a user interaction module configured to receive from a user a request for information; and
a server device in network communication with the client device, the server device being remotely located with respect to the client device and configured to receive the user request for information from the client device, the server device further comprising a request module configured to:
perform a search for the requested information to obtain a set of search results,
retrieve goal data indicative of one or more goals of the user,
retrieve personality data indicative of one or more personality traits of the user,
filter the set of search results based at least in part on the goal data, and
generate presentation results for presenting one or more responses to the user according to the personality data, the one or more responses comprising at least a portion of the filtered search results.

13. The computing system of claim 12, wherein the client device further comprises a display, and wherein the user interaction module is further configured to receive the presentation results and to communicate the presentation results to the user through a virtual character on the display.

14. The computing system of claim 12, wherein the client device comprises a mobile phone.

15. The computing system of claim 12, wherein the client device comprises a computer.

16. The computing system of claim 12, wherein the request module is further configured to retrieve the goal data and the personality data from at least one database.

17. The computing system of claim 12, further comprising a staff computing device in network communication with the server device, the request module being further configured to send the user request for information to the staff computing device when performing a search for the requested information.

18. The computing system of claim 12, wherein the presentation results are in the form of an eXtensible Markup Language (XML) document.

19. A system for providing personalized responses to user requests, the system comprising:
a plurality of client devices, each client device comprising a user interface for displaying a virtual character, each client device further comprising a user interaction module configured to receive from a user one or more requests for information; and
a server device in network communication with each of the plurality of client devices, the server device being configured to receive the one or more user requests for information from one or more of the plurality of client devices, the server device further comprising a request module configured to, for each of the one or more user requests:
perform a search for the requested information to obtain a set of search results,
retrieve goal data indicative of one or more goals of the user,
retrieve personality data indicative of one or more personality traits of the user,
filter the set of search results based at least in part on the goal data,
generate presentation results for presenting one or more responses to the user according to the personality data, the one or more responses comprising at least a portion of said filtered search results, and
send the presentation results to the particular client device that received the particular user request for information,
and wherein the particular client device is configured to communicate the presentation results to the user via the virtual character of the particular client device.

20. The system of claim 19, wherein the request module is further configured to perform the search by accessing a database of responses to previous requests from individuals other than the user.
